(19) United States
(12) Patent Application Publication
(10) Pub. No.: US 2010/0049355 A1
(43) Pub. Date: Feb. 25, 2010

(54) METHOD FOR DETERMINING TOOL'S PRODUCTION QUALITY

(75) Inventors: YIJ CHIEH CHU, TAIPEI COUNTY (TW); CHUN CHI CHEN, TAIPEI CITY 115 (TW); YUN-ZONG TIAN, TAICHUNG COUNTY 422 (TW); CHENG-HAO CHEN, TAIPEI CITY 105 (TW)

Correspondence Address: ROSENBERG, KLEIN & LEE, 3458 ELLICOTT CENTER DRIVE-SUITE 101, ELLICOTT CITY, MD, 21043, US

(73) Assignee: INOTERA MEMORIES, INC., TAOYUAN COUNTY 333 (TW)

(21) Appl. No.: 12/276,805

(22) Filed: Nov. 24, 2008

(30) Foreign Application Priority Data
Aug. 20, 2008 (TW) 97131687

(51) Int. Cl. G06F 19/00

(52) U.S. Cl. 700/110

(57) ABSTRACT

A method for determining manufacturing tool production quality includes providing a table with manufacturing process data. The table is analyzed and a contingency table is established. The contingency table comprises several manufacturing tools, manufacturing processes, and the number of occurrences of bad lots. Split the contingency table up into a plurality of sub-tables. Use Cochran-Mantel-Haenszel test for determining the number of bad lots produced by the manufacturing tools and getting a plurality of statistics. Translate the statistics into a plurality of P-values. Sort the P-values for examining data automatically. Draw a line chart for detecting substandard manufacturing tools. As a result, users can diagnose the quality of the manufacturing tools.

### FIELD OF THE INVENTION

The present invention relates to a method for determining the production quality of manufacturing tools, in particular to a method that can diagnose a manufacturing tool of substandard quality.

### DESCRIPTION OF RELATED ART

Yield is an important index in the tradition semiconductor manufacturing factory. On one hand yield represents the efficiency of the semiconductor manufacturing process, on the other hand yield has an effect on the costs of semiconductor manufacturing. Thus, yield influences the profits of semiconductor manufacturing. For the reason, how to improve yield is the most important issue for the semiconductor manufacturing factory.

The semiconductor manufacturing factory has several manufacturing tools. The production quality of each manufacturing tool influences the yield of a semiconductor assembly line. The production quality of each manufacturing tool is recorded in daily records and saved in a database. But the records are often neglected. As a result, nobody knows when a manufacturing tool causes problems until a plurality of bad lots are produced. Therefore the occurrence of bad lots may incur large financial losses. If we can diagnose substandard manufacturing tools and the degree of the substandard condition via the records, the problems would be solved earlier. The yield and the cost of manufacturing would be improved.

Therefore, in view of this, the inventor proposes the present invention to overcome the above problems based on his expert experience and deliberate research.

### SUMMARY OF THE INVENTION

The object of the present invention is to provide a method for determining the production quality of the manufacturing tools. Using a method for determining production quality to find out a manufacturing tool with a substandard production quality. The problems can be solved as soon as possible. The yield and the cost are improved.

For achieving the object described above, the present invention provides a method for determining the production quality of the manufacturing tools. The steps include providing a table with manufacturing process data, analyzing the table and establishing a contingency table. The contingency table comprises manufacturing tools, manufacturing processes, and the number of occurrences of bad lots. The contingency table is split up into a plurality of sub-tables. The Cochran-Mantel-Haenszel test is used for determining the number of bad lots produced by the manufacturing tools and getting a plurality of statistics. The statistics are translated into a plurality of P-values. Sort P-values for examining data automatically. Draw a line chart for detecting substandard manufacturing tools.

The present invention has advantageous effects as follows. Use Cochran-Mantel-Haenszel test for determining the number of bad lots produced by the manufacturing tools, and translate the statistics into a plurality of P-values. Sort the P-values for examining data automatically. Draw a line chart for detecting substandard manufacturing tools. Thus, the problems can be solved as soon as possible. The yield and the cost are improved.

In order to further understand the characteristics and technical contents of the present invention, a detailed description is made with reference to the accompanying drawings. However, it should be understood that the drawings are illustrative only but not used to limit the present invention thereto.

### BRIEF DESCRIPTION OF THE DRAWINGS

FIG. 1 is a flow chart showing a method for determining manufacturing tool production quality of the present invention;

FIG. 2 is a reference table of the present invention showing manufacturing process data;

FIG. 3 is a statistic chart showing the contingency table of the present invention;

FIG. 4 is a statistic chart showing the sub-table of the present invention;

FIG. 5 is a statistic chart showing a another contingency table of the present invention;

FIG. 5A is a line chart showing the manufacturing tools F and G of the present invention;

FIG. 5B is a line chart showing the manufacturing tools C, D and E of the present invention;

FIG. 5C is a line chart showing the manufacturing tools F and G of the present invention;

FIG. 6 is a distribution chart showing the Chi Square test as the degrees of freedom is 1;

FIG. 7 is a statistic chart showing the manufacturing tools versus P-values;

FIG. 8 is a line chart showing the manufacturing tools, manufacturing process, and number of bad lots.

### DETAILED DESCRIPTION OF PREFERRED EMBODIMENTS

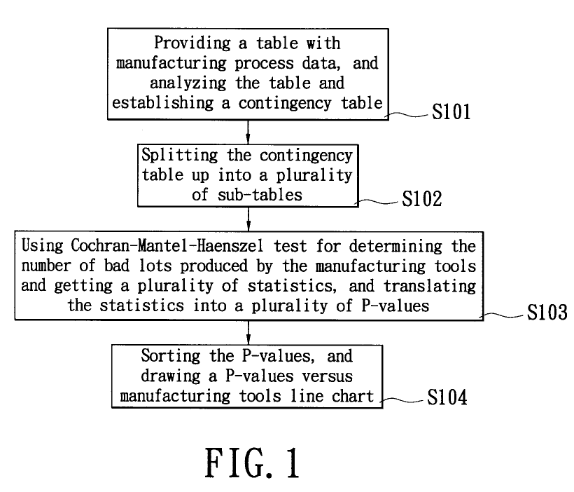

Please refer to FIG. 1. The present invention discloses a method for determining manufacturing tool production quality which includes:

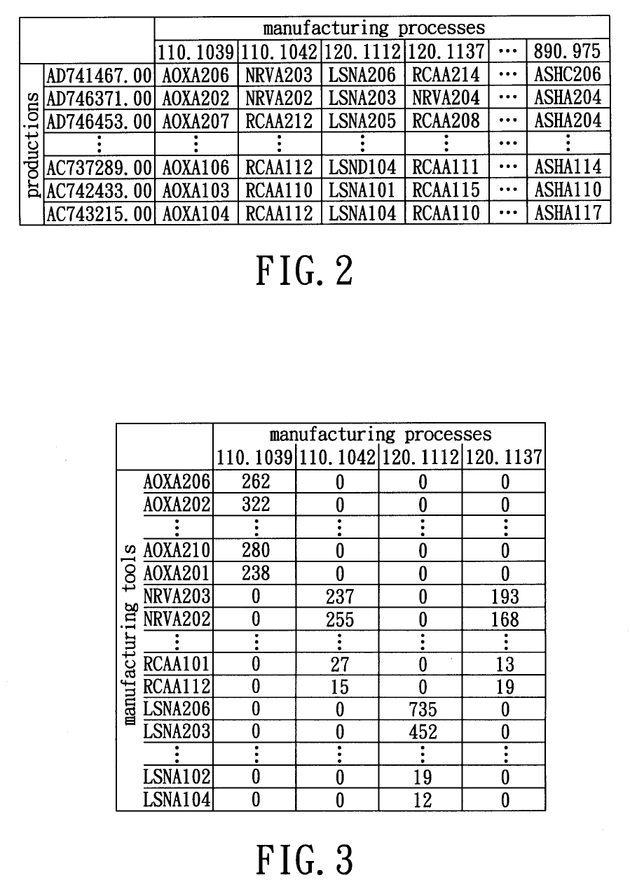

(S01) Collecting a chart with daily semiconductor manufacturing process data (please refer to FIG. 2). The chart comprises semiconductor products (AD741467.00, AD746371.00 . . . ), manufacturing process ID numbers (110.1039, 110.1042 . . . ), and manufacturing tools (AOXA206, AOXA202 . . . ). The products are manufactured by the manufacturing tools in the manufacturing processes. The chart has a plurality of columns and rows. In this embodiment, the column titles of the chart represents the manufacturing processes. The row titles of the chart represents the semiconductor tools. The chart is analyzed and the information about products is combined. For example, combine bad lot quantities with the chart and establish a contingency table (please refer to FIG. 3 ). The bad lot quantities are generated by the manufacturing tools during the manufacturing processes. The contingency table includes parts of the manufacturing tools of the chart, parts of the manufacturing processes of the chart, and parts of the bad lot quantities of the chart. The column titles of the contingency table represent the manufacturing process ID numbers (110.1039, 110.1042 . . . ). The row titles of the contingency table represent the manufacturing tools (AOXA206, AOXA202 . . . ).

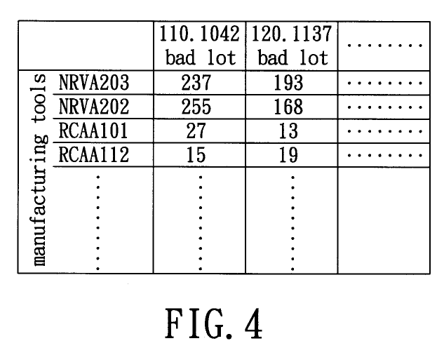

(S102) Split the contingency table by conditional independence to choose the manufacturing tools which are part of the same manufacturing processes, and then make a sub-table (please refer to FIG. 4 ). The row titles of the sub-table represent the manufacturing tools (picked from FIG. 3 ). The column titles of the sub-table represent the manufacturing processes (picked from FIG. 3). Each of the manufacturing tools corresponding to its manufacturing process has a quantity of the bad lot.

(S103) In order to determine whether there is relation between manufacturing tools, manufacturing processes, and number of bad lots, we use the statistical method of the Cochran Mantel Haenszel Test to determine whether the number of bad lots produced by the manufacturing tools while performing the manufacturing processes in the sub-table is similar. By means of the Cochran Mantel Haenszel Test, we can determine the rate distribution of the statistics, and determine a plurality of P-values of the manufacturing tools. Assuming the production quality of the manufacturing tools is similar (Hypothesis test), the following formula applies:

$$C M H = \frac{{[ {\sum }_{i = 1}^{n} ( {n}_{iK} - {μ}_{iK} ) ]}^{2}}{{\sum }_{i = 1}^{n} var ( {n}_{iK} )} {}^{d} {χ}^{2} ( i )$$

$$if C M H > {χ}_{α ( i )}^{2} p < α ,$$

where CMH is the test statistic, η is the observed frequencies, μ is the expected frequencies, χ² is chi-square, α is the level of significance set by the user, P represents the smallest value of the level of significance that can reject null hypothesis (H0), and K represents a manufacturing process.

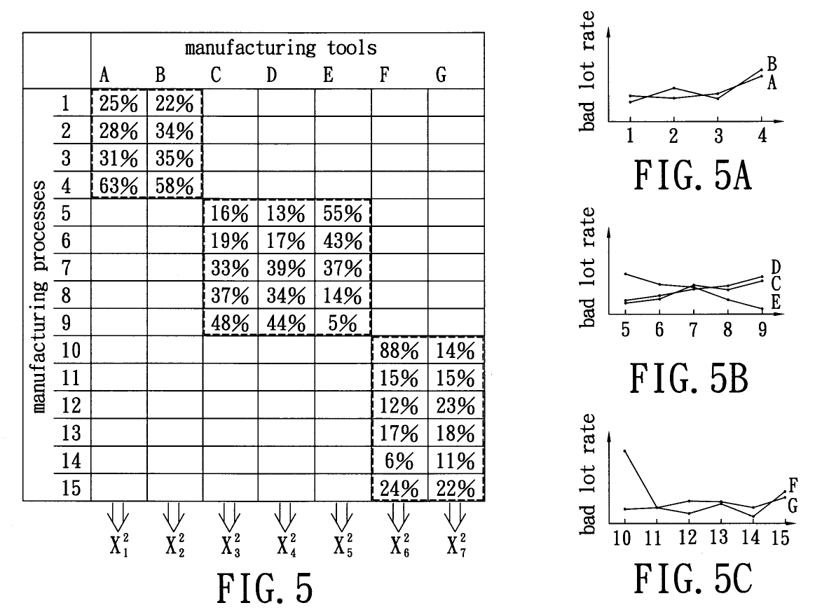

Please refer to FIG. 5 to FIG. 5C. The FIG. 5 is another contingency table. The row titles represent manufacturing tools (A˜G). The column titles represent manufacturing process ID numbers (1˜15). Each of the manufacturing tools has an associated number of bad lots while performing its related manufacturing processes. Split the manufacturing tools which run the same manufacturing processes. Draw a line chart according to the number of bad lots of the manufacturing tools. We suppose the production quality of the manufacturing tools are similar, and then the lines in the chart will be similar too. For example, the manufacturing tools A and B in the FIG. 5A. The substandard manufacturing tools are differentiated obviously in the line chart. For example, the manufacturing tool E in the FIG. 5B and the manufacturing tool F in the FIG. 5C.

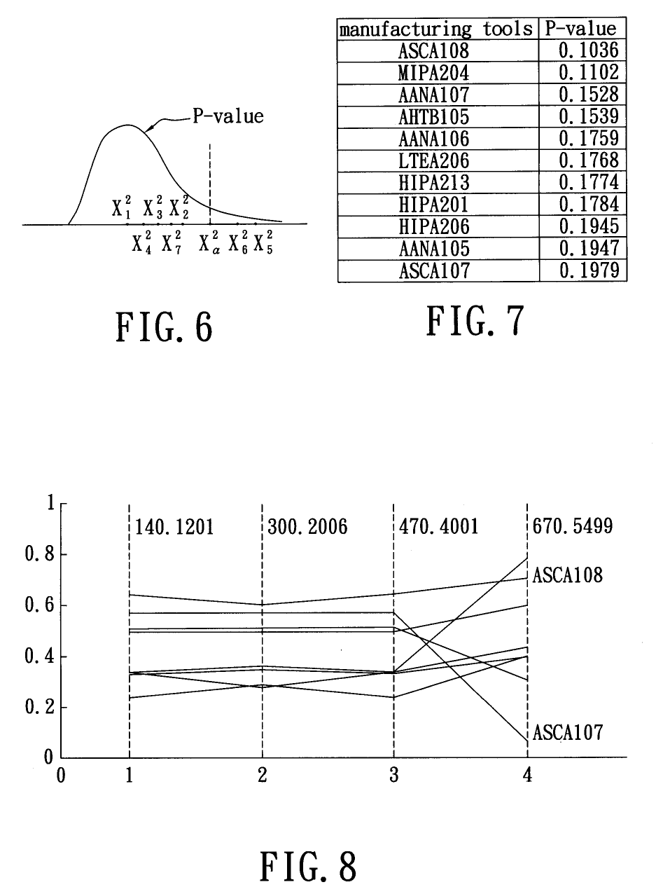

Please refer to FIG. 5 and FIG. 6, the manufacturing tools (A˜G) can be figured out their statistics (e.g. χ²^{₁}˜χ²^{₇}) and draw the statistics in a distribution chart. For example, the FIG. 6 is a distribution chart as the degrees of freedom is 1. We suppose that user has decided a standard value of the significant level α. In the FIG. 6, we know the statistics χ²^{₅} and χ²^{₆} of the manufacturing tools E and F are greater than the statistic χ²^{_{α}} of the significant level α. In another word, it means the odds ratios of the manufacturing tools E and F exceed the standard value. The P-values of the manufacturing tools E and F are smaller than the significant level α. Furthermore, the CMH value is equal to the statistics (χ²^{₁}˜χ²^{₇}) of the manufacturing tools as the degrees of freedom of the Chi Square test is 1.

(S104) Please refer to FIG. 7, the P-values are arranged in an increasing sequential order. FIG. 7 provided another set of manufacturing process data according the above method. In the FIG. 7, we know the P-value of the manufacturing tool ASCA108 is the smallest. We suppose the manufacturing tool ASCA108 and manufacturing tool ASCA107 are in the same sub-table, the odds ratio of the manufacturing tool ASCA108 is more significant than manufacturing tool ASCA107. That is to say the number of bad lots produced by the manufacturing tool ASCA108 is larger than the number of bad lots produced by the manufacturing tool ASCA107.

Using daily manufacturing process data, for example, the quantities of the good lots and bad lots. Figure out the number of bad lots produced by the manufacturing tool ASCA107 and ASCA108 while performing the manufacturing processes. Draw a line chart of the manufacturing tools versus the number of bad lots. Please refer to FIG. 8, the unsigned lines represent the manufacturing tools in the same sub-table. We can find out the manufacturing tool with different quality in each of the manufacturing processes via the different line in the line chart. For instance, the manufacturing tool ASCA108 has a higher number of produced bad lots. The manufacturing tool ASCA107 in the manufacturing process 670.5499 has a lower number of produced bad lots.

The present invention is provided a method that users use the Cochran-Mantel-Haenszel test for determining the number of bad lots produced by the manufacturing tools and getting a plurality of statistics. Translate the statistics into a plurality of P-values. Sort the P-values for examining data automatically. Draw a line chart for detecting substandard manufacturing tools. Thus, the problems can be solved as soon as possible. The yield and the cost are improved.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for determining manufacturing tool production quality, including: providing a table with manufacturing process data;
analyzing the table and establishing a contingency table, the contingency table comprising a plurality of manufacturing tools, a plurality of manufacturing process ID numbers, and the corresponding number of occurrences of bad lots;
splitting the contingency table up into a plurality of sub-tables;
Using Cochran-Mantel-Haenszel test for determining the number of bad lots produced by the manufacturing tools and getting a plurality of statistics, and translating the statistics into a plurality of P-values;
sorting the P-values, and drawing a P-values versus manufacturing tools line chart for detecting substandard manufacturing tools.

2. The method for determining tool quality according to claim 1, wherein the column titles of the contingency table represent the manufacturing processes, the row titles of the contingency table represent the manufacturing tools, and the cells represent the number of bad lots while the manufacturing tools perform the manufacturing processes.

3. The method for determining tool quality according to claim 1, wherein the manufacturing tools in the sub-table perform the same manufacturing processes.

4. The method for determining tool quality according to claim 1, wherein the table with manufacturing process data comprises a plurality of products, a plurality of manufacturing tools, and a plurality of manufacturing process ID numbers.

5. The method for determining tool quality according to claim 1, wherein the line chart shows manufacturing tools versus the number of bad lots while performing the manufacturing processes.

6. The method for determining tool quality according to claim 1, wherein the P-values are arranged in an increasing sequential order.

7. The method for determining tool quality according to claim 1, wherein in Cochran-Mantel-Haenszel test, the degrees of freedom of the chi-square test is 1.
